(19) United States
(12) Patent Application Publication
(10) Pub. No.: US 2009/0249418 A1
(43) Pub. Date: Oct. 1, 2009

(54) Repository for information about streaming video/audio channels

(75) Inventors: Cristina Alastruey Gracia, Barcelona (ES); Carles Llorach Marine, Barcelona (ES)

Correspondence Address: BRENDA POMERANCE;LAW OFFICE OF BRENDA POMERANCE, 310 West 52 Street, Suite 27B, NEW YORK, NY, 10019, US

(73) Assignee: Channer Medianet, S.L., Barcelona (ES)

(21) Appl. No.: 12/079,848

(22) Filed: Mar. 28, 2008

(51) Int. Cl. H04N 7/173

(52) U.S. Cl. 725/114

(57) ABSTRACT

A computing platform accessible through a communication network enables users to search among television channels available through the communication network, to select a channel, and to receive the selected channel on a user device, generally a mobile device but sometimes a non-mobile device. Users can readily change among channels. The computing platform stores information about the user, such as their favorite channels and demographic information, and also monitors the status of the television channels. When a channel is not working properly, the platform notifies the user device.

### BACKGROUND OF THE INVENTION

The present invention relates to a computer system that assists mobile users in receiving streaming video/audio content, and more particularly, is directed to a computer system that serves as a searchable repository for information about Internet streamed television.

A television signal is a linear stream of video information and accompanying audio information in one of several accepted formats for a television signal, such as NTSC in the United States, or PAL in Europe.

Television signals are usually delivered in broadcast format, that is, one-to-many format able to accommodate as many users as are capable of receiving the broadcast signal. Streaming video and/or audio signals are delivered in a one-to-one format, from a server able to accommodate a particular number of users at a particular signal quality; if more than the particular number wishes to receive the streamed signal, the excess users are denied service due to insufficient server capacity.

Streamed video and accompanying audio refers to a video signal and accompanying audio that is sent from a source to one or more destinations in a linear stream for display on a single device. Streamed video signals are generally provided in a digital format different than television signals. For present purposes, users consider television and streamed video as interchangeable, since the user expects to just watch and listen to the media in linear fashion, not to interact with it—which would result in a non-linear display.

As used herein and in the claims, a television signal means video and/or audio content that is intended for linear presentation to a user, irrespective of the signal format.

Mobile devices, such as advanced cellphones, have had the capability to receive and display television signals for some time now.

JumpTV, www.jumptv.com, is the world's largest broadcaster of international and sports events over the Internet. The majority of JumpTV's content is streamed live; much of it is fresh content unavailable through any other means. JumpTV enables its subscribers to view certain regional-only channels while the subscribers are outside of the region, usually by obtained exclusive outside-of-region distribution rights from the regional channel. JumpTV also offers programming on a video-on-demand (VoD) basis. However, JumpTV negotiates Internet broadcast rights for its events, so if a content provider does not work out a deal with JumpTV, the provider's content is unavailable through JumpTV.

MobiTV, www.mobitv.com, provides a platform for content delivery over mobile and broadband networks, delivering live television, premium and primetime programming, video-on-demand, satellite and digital music services from the top broadcast and cable television networks and major music labels to millions of users worldwide. The MobiTV platform has the following characteristics:
Ingestion of live, VOD and guide data via satellite cable head-in, IP-based feeds, files, etc.
Support for selected standard video and audio codecs
Management of program guide and location based service (LBS) data, advertising assets and content provider integration
Seamless delivery across any network including 3G, WiFi, WiMAX and DVB-H
Fast session start-up and channel changing
Real time network handover and bandwidth adaptation capabilities
Bandwidth optimization support for unicast, multicast and broadcast
Targeted in-stream ad insertion
Compelling and customizable user interface
Dynamic program guide for easy navigation and content discovery
Personalization and interactivity
Consistent and integrated user experience across multiple device types (handset, PC, MIDs, Plasma TV, etc.)
Carrier-grade infrastructure ensuring high availability, uptime and response
24/7 Network Operations Center
Geographically redundant data centers
Robust service monitoring and reporting tools
   However, if a content provider does not work out a deal with MobiTV, the provider's content is unavailable through MobiTV.

Thus, there is a need for a platform that is accessible by a user, and which enables the user to readily access the various content providers that operate independently and usually provide free television content over the Internet.

### SUMMARY OF THE INVENTION

In accordance with an aspect of this invention, there are provided a method of and a system for using a repository for television channels available through a communication network. A server is coupled to the communication network to provide information from the repository in response to a request. A data storage stores the repository, the repository having a record for each of the television channels, the record including an operational status of the television channel, the television channel operative in a streaming mode, the television channel provided by a party other than a provider of the repository.

Each of the channels in the repository is queried to obtain the operational status of the channel.

When the request is a search request, the information provided from the repository in response to the search request includes operational status information for each of the channels satisfying the search request.

A favorite channels list for a user of the repository is also stored. When the request is a favorite channels request, the information provided from the repository in response to the favorite channels request includes operational status information for each of the channels in the favorite channels list.

It is not intended that the invention be summarized here in its entirety. Rather, further features, aspects and advantages of the invention are set forth in or are apparent from the following description and drawings.

### BRIEF DESCRIPTION OF THE DRAWINGS

FIG. 1 is a configuration diagram showing the hardware elements involved in the present invention;

FIG. 2 is a flowchart showing a set-up phase for a mobile device;

FIGS. 3A-3B are a flowchart showing an operational phase; and

FIGS. 4A-4E are diagrams of screen displays for a mobile device according to the present invention.

### DETAILED DESCRIPTION

As used herein and in the claims, a television signal means video and/or audio content that is intended for linear presentation to a user.

An automated repository accessible through a communication network enables users to search among television channels available through the communication network, to select a channel, and to receive the selected channel on a user device, generally a mobile device but sometimes a non-mobile device. Users can readily change among channels. The repository stores information about the user, such as their favorite channels and demographic information, and also monitors the status of the television channels. When a server for a channel is not working properly or is at its streaming capacity, the repository notifies the user device. If the channel changes its network address, that is, its universal resource locator (URL), the repository automatically propagates the change to all users that have designated the channel as one of their favorites.

The repository represents a large market for new channels. By aggregating channel information into a centralized repository and facilitating access to the channels, new channels are more likely to succeed as the marketing effort is reduced when the new channels are accessible through the repository.

Additionally, the repository monitors user search requests, and can suggest to content providers that there is unmet need for certain programming.

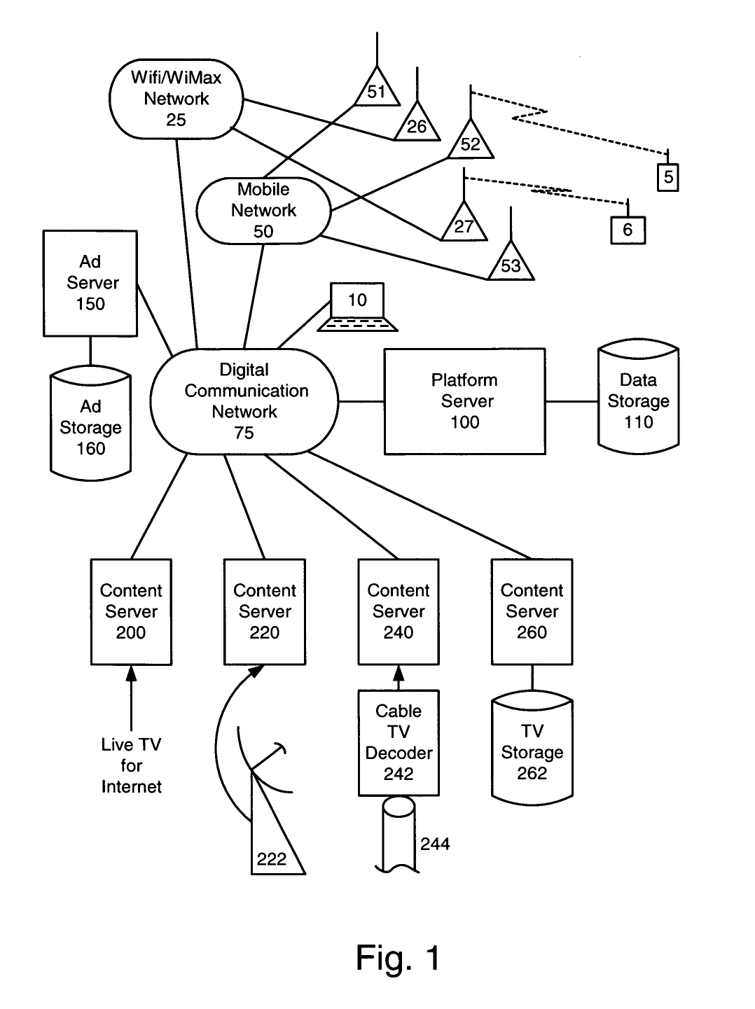

Referring now to the drawings, and in particular to FIG. 1, there is illustrated a configuration diagram showing hardware elements. FIG. 1 shows mobile devices 5, 6; personal computer 10; Wifi/Wimax network 25 having antennas 26, 27; cellular network 50 having antennas 51, 52, 53; digital communication network 75 such as the Internet; platform server 100 having data storage 110; ad server 150 having ad storage 160; and television content providers 200, 220, 240, 260.

Mobile device 5 is a cellular telephone having a display for presenting text screens and video to a user and also having suitable means for presenting an audio signal to a user, such as a speaker and/or headset jack. Any of the various cellular transmission standards supporting digital video are usable, such as 3G or WCDMA. Mobile device 5 has suitable means for accepting input from a user, such as a keyboard, touch screen, voice interface, and so on. Generally, mobile device 5 has a small display, and a human noticeable response time when retrieving data according to a request/response protocol. In some cases, mobile device 5 is able to use a non-cellular channel such as WiFi or WiMax when available, or a cellular channel when a non-cellular channel is unavailable.

Mobile device 6 is, for example, a personal digital assistant (PDA) not equipped for cellular service but able to communicate via a wireless channel such as WiFi or WiMax.

Personal computer 10 is a general purpose computer typically used with a wireline connection, such as a so-called desktop or notebook computer. In some cases, personal computer 10 is able to communicate via WiFi, WiMax or cellular. Personal computer 10 executes suitable software, such as an Internet browser, to be able to send and receive information via digital communication network 75.

The term “user” generally refers to a user of mobile device 5, 6 or personal computer 10, and is an individual who wishes to have television displayed on their device. Typically, the user is willing to accept advertising in exchange for provision of free television.

Each of mobile devices 5, 6 and personal computer 10 has a digital address so that information can be sent thereto via communication network 75. Generally, the digital address is constant while the device is communicating via communication network 75 during a session (continuous usage period), but differs from session to session.

WiFi/WiMax network 25 is a suite of computers and communications equipment, including antennas 26, 27, for enabling suitably configured devices, such as mobile devices 5, 6 and personal computer 10, to send and receive information via digital communication network 75.

Mobile network 50 is a suite of computers and communications equipment, including antennas 51, 52, 53, for enabling cellular telephones to communicate with each other and with a public switched telephone network (not shown), and further for enabling suitably configured devices, such as mobile device 5 and personal computer 10, to send and receive information via digital communication network 75.

Digital communication network 75 is a suite of computers and communications equipment enabling digital packet-based communication generally according to a request/response protocol such as hypertext transfer protocol (http), and further enabling so-called streaming of audio and/or video signals from a source to one or more destinations.

Platform server 100 is one or more general purpose computers and suitable communication equipment configured to:
communicate via digital communication network 75 using a request/response protocol;
maintain a repository of television content providers that provide television channels accessible through digital communication network 75;
search communication network 75 for new television channels and, if suitable, automatically include characteristics information about the channels in the computing platform's channel repository;
enable television content providers to include their channels in the repository;
periodically check the availability status of the television content providers in its repository;
cooperate with software in user devices, such as mobile devices 5, 6 and personal computer 10, to enable registered users to browse the television channel repository, to search and filter the channel repository according to user-specified criteria, and to connect to the television channels;
enable users to register for access to its repository and connection services;
maintain account information for registered users, including their log-in name, email address, demographic information, usage information and preferences specified by the users, such as their favorite channels;
cooperate with ad server 150 to provide advertising to registered users before, during and/or after the registered users view the television channels in the channel repository;
cooperate with content servers 200, 220, 240, 260 to provide accounting for sharing of revenue from selected advertising supplied to users;
cooperate with other servers (not shown) accessible via communication network 75 to provide additional services to users of the repository and connection services, for example, communicating with other users to discuss television channels via instant messaging, short text updates such as enabled by the Twitter service, and so on;
execute suitable administrative software such as billing, audit trail, backup and so on, for provision of reliable services.
   Platform server 100 uses data storage 110 for storage and retrieval of data for the functions listed above.

Data storage 110 includes the following:
downloadable executable software programs for enabling mobile devices 5, 6 to use the services provided by platform server 100;
a channel repository including a list of channels that provide streamed video and/or audio via communication network 75; descriptive information for each channels includes its universal resource locator (URL), hours of operation, categories of programming, fees, whether advertising is permitted during streaming such as banner ads; and current operational status information;
user account information, including information explicitly provides by the user during registration, as updated from time to time by the user; and user operational information such as last channel viewed, last search, favorite channels and so on; and
usage information for billing purposes, and to enable production of reports relating to channel popularity, types of users watching a particular channel, number of connection requests denied due to lack of capacity, and so on.
   The channel repository is created and maintained using suitable procedures such as (i) manually identifying channels and adding them to the channel repository; (ii) a software interface provided via platform server 100 enabling a channel provider to submit information about its channel, and (iii) so-called spider software that automatically “crawls” through communication network 75 seeking new channels and verifying the continuing existence of known channels.

Table 1 shows a typical record of the channel repository in data storage 110.

TABLE 1

channel ID no.
network address
status
hours of operation
format (video/audio)
name
type of programming
primary language
additional languages
source country/region
popularity
reserved1
reserved2

The “network address” field includes any information needed to create a streaming request for the channel.

Ad server 150 is one or more general purpose computers and suitable communication equipment configured to communicate via digital communication network 75 and to receive and store advertisements, such as graphics, audio, video and text, and to provide these advertisements in response to requests for ads. Generally, an ad request specifies a category for an ad, and a media type. Ad server 150 uses ad storage 160 for storage and retrieval of data for the functions described above.

Content servers 200, 220, 240, 260 are each one or more general purpose computers and suitable communication equipment configured to communicate via digital communication network 75 and to receive requests for television, and to provide the requested television. Other content servers are also accessible via communication network 75, and are not shown for brevity.

Content server 200 provides live, real-time television, such as news, sports, talk shows and so on, intended to be streamed to users via communication network 75 and not via any other distribution method.

Content server 220 receives satellite television broadcasts via satellite antenna 222, and reformats the broadcasts for streaming via communication network 75.

Content server 240 receives cable television broadcasts from television cable 244, decodes the broadcasts if necessary using cable television decoder 242, and reformats the broadcasts for streaming via communication network 75.

Content server 260 accesses television programs stored on television storage 262, and provides the stored programs in response to requests. In some cases, content server 260 has arranged with platform 100 to continually provide the most popular segments in storage 262, ranked by cumulative views or views in the most recent time period, as a sort of synthetic streamed channel.

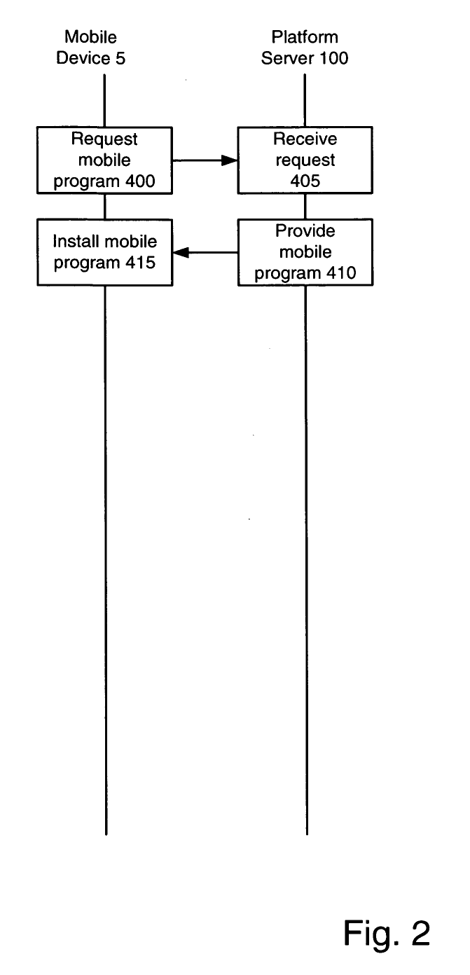

FIG. 2 is a flowchart showing a set-up phase for mobile device 5.

At step 400, mobile device 5 requests download of a special application program from platform server 100. At step 405, platform server receives the request. At step 410, platform server provides the requested application program to mobile device 5. At step 415, mobile device 5 receives the requested program and installs it using its local operating system, such as the Windows Mobile operating system. The application program remains installed in mobile device 5 until the user explicitly uninstalls it.

In other embodiments, the user obtains the special application program via different procedures. In other embodiments, the special application program is downloaded from mobile network 50, attached to an e-mail, transferred from mobile device 5 to mobile device 6 through a software mating procedure usually involving wireless communication, installed in mobile device 5 by its manufacturer, or distributed via a data storage medium such as compact disk (CD) or memory stick.

Any suitable technique may be used to start the special applications program. For example:
go to the Programs file, and actuate a special icon created during installation of the application program;
from the operating system's main screen, actuate a special icon created during installation of the application program;
from the operating system's start menu or recently-used-programs list, actuate the special icon representing the application program;
go to the file directory for the application program, and actuate the executable file for the application.

When the mobile application program starts for the first time, it displays a log-in screen with a registration button that, when actuated, leads to a registration screen. The user provides information, and the application program gathers the user-provided information to create a registration request data packet, and sends the registration request to platform server 100 via communication network 75. The user-provided information minimally comprises a log-in name and password, and may additionally include other identifying information such as email address and/or name, demographic information, preferences relating to information of interest, privacy, accessibility by other users and so on, log-in names of friends using the service and other information. Platform server 100 creates an account for the user, and responds to mobile device 5 via communication network 75 that the user is registered.

In other embodiments, registration occurs differently. For example, in one embodiment, a user of personal computer 10 goes to the website provided by platform server 100 to access the log-in screen with a registration button.

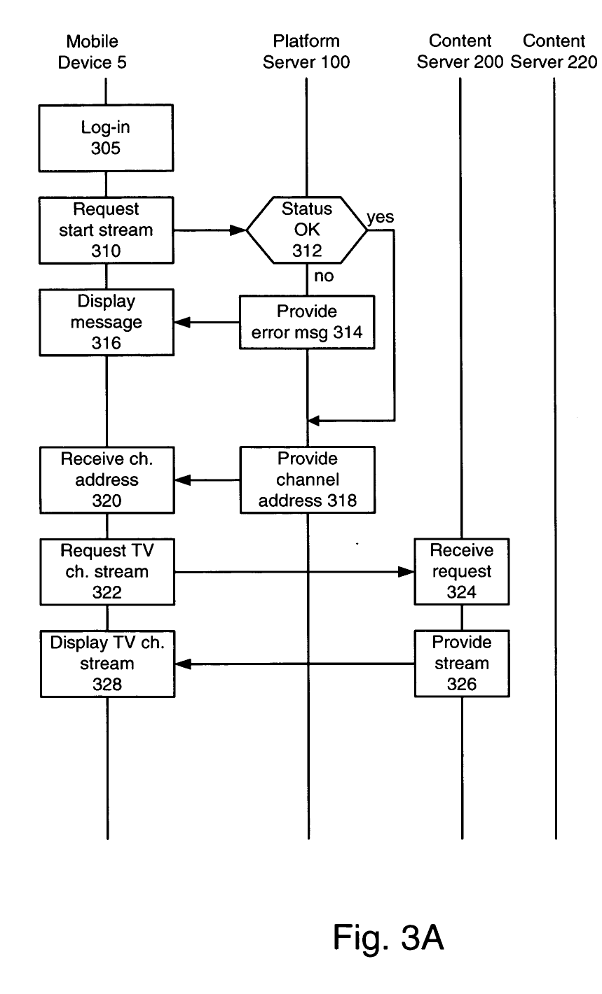

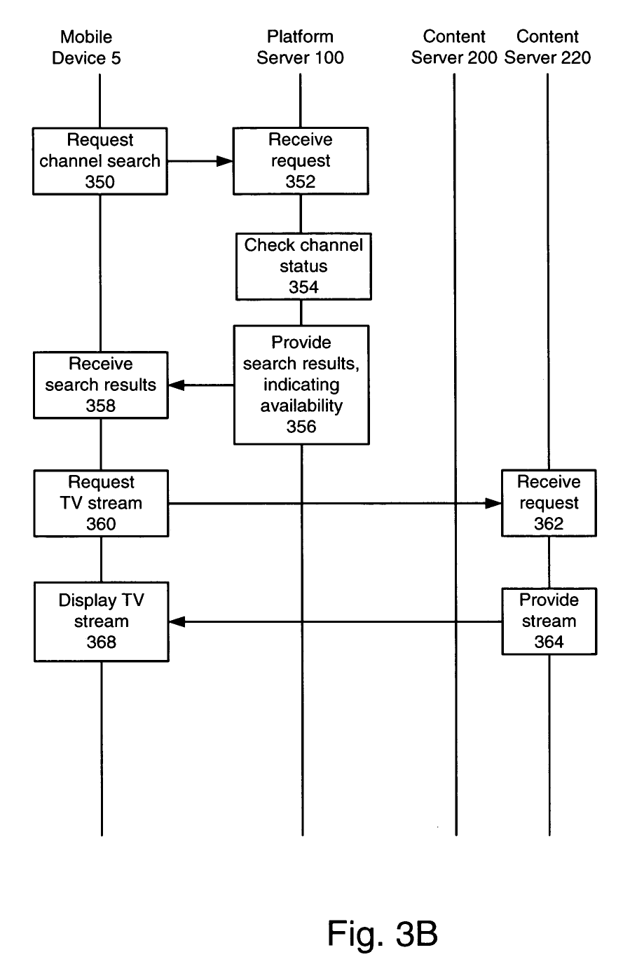

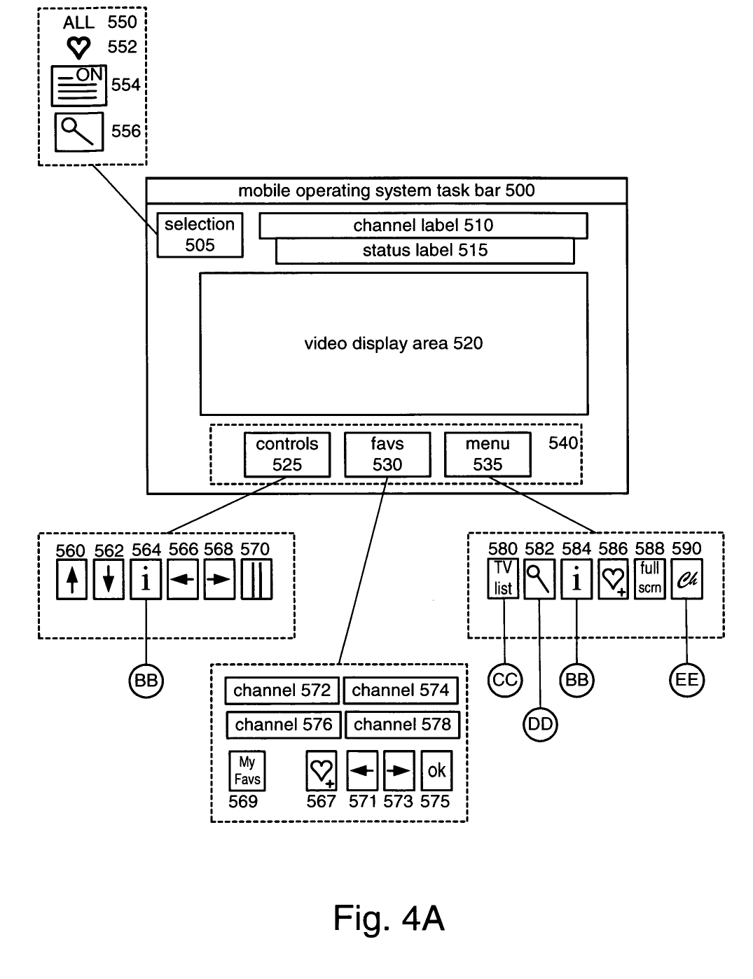

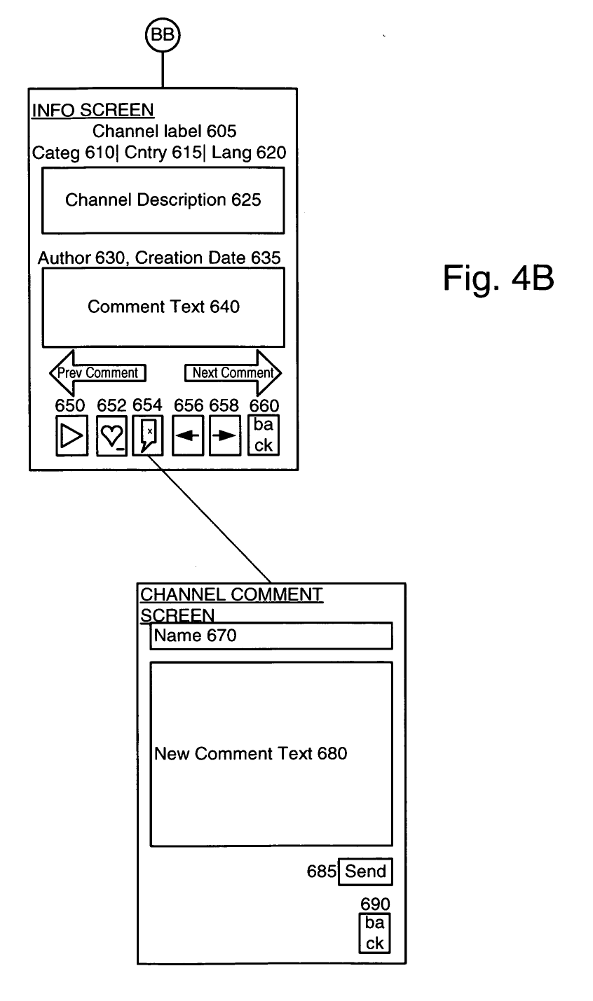

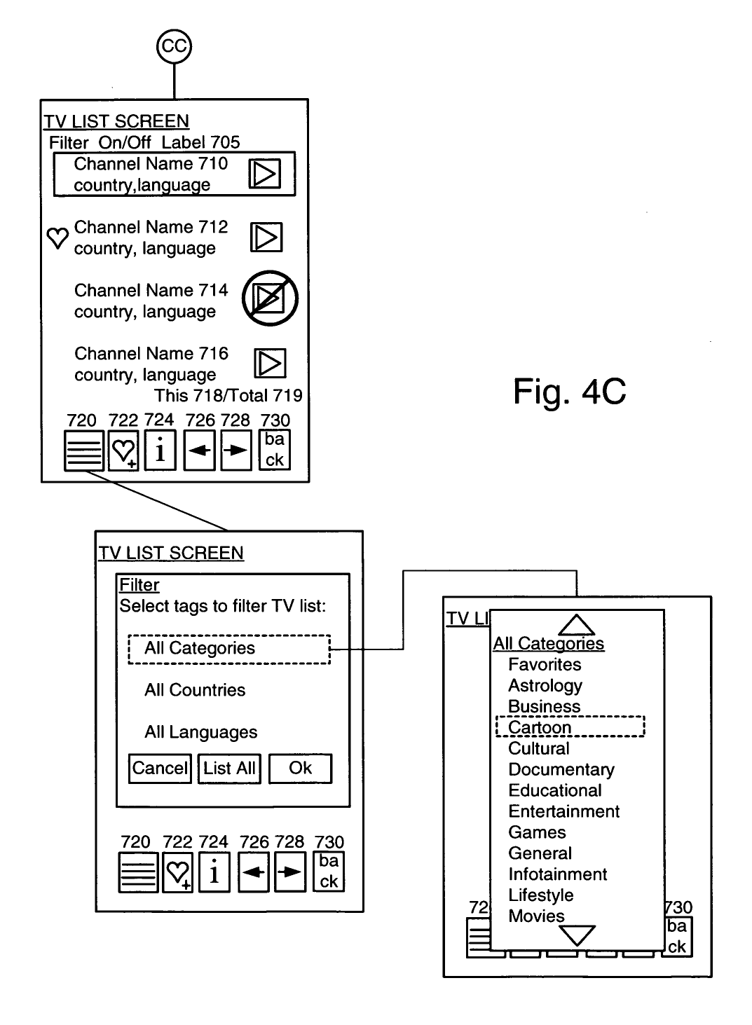

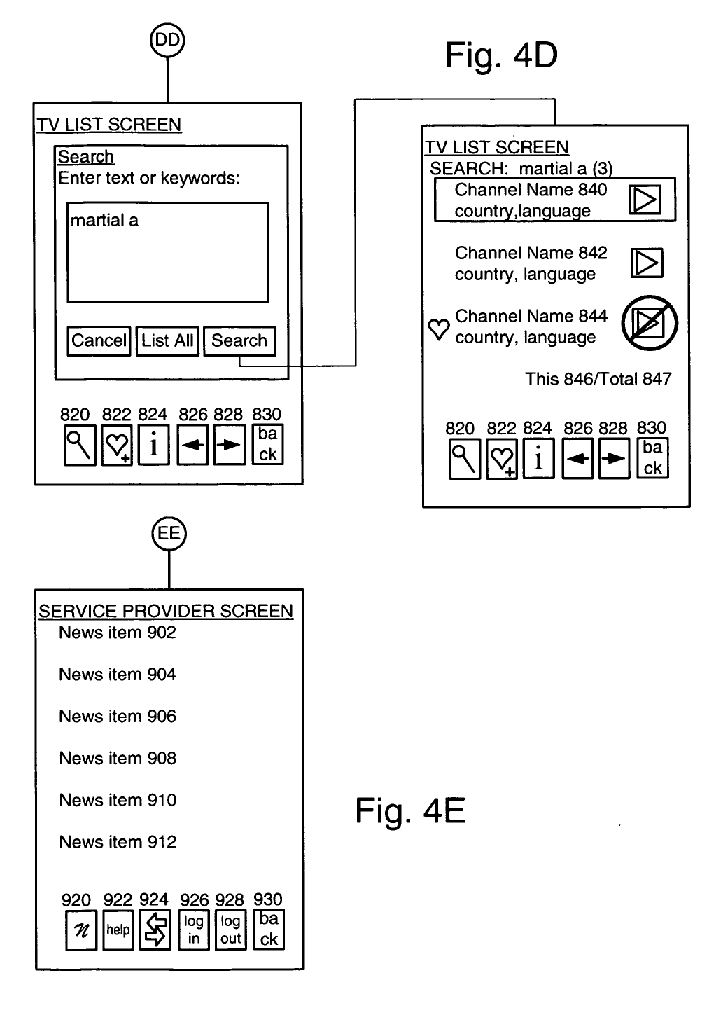

After registration, and each time the mobile application program is activated, a log-in screen is displayed to the user. The user provides his/her log-in name and password. The application program gathers the user-provided information and creates a log-in request, and via communication network 75, sends the log-in request to platform server 100, which responds to mobile device 5 with a log-in acknowledgement, and arranges a connection to the start-up channel, discussed below with regard to FIG. 3. Mobile device 5 displays the screen shown in FIG. 4A with the start-up channel.

If, when logging in, the user selects a “remember me” option, then mobile device 5 remembers the user's login name and password, and each time the mobile application program is activated, automatically creates and sends a log-in request to platform server 100.

During execution of the application program, the user can, via the operating system, switch to another program, causing the application program to become a background program. The user can switch back to the application program via any convenient operating system provided technique, such as clicking the icon for the application program.

The user terminates execution of the application program via any suitable operating system, such as closing the icon representing the application program.

FIGS. 3A-3B are a flowchart showing an operational phase.

Server 100 regularly queries each channel in its repository, such as every 3 minutes or at another suitable interval, and indicates whether the channel is operative and has capacity to stream to another user, i.e., is available. In one embodiment, the channels are checked in the same sequence, repeatedly, each channel appearing once in the sequence. In another embodiment, popular channels are checked more frequently than other channels.

Server 100 updates the network address for a channel in response to (a) notice from the channel that its network address is changing, and (b) notice resulting from the periodic querying that occurs automatically. In some embodiments, server 100 produces exception alerts regarding network addresses, and a human determines the updated network address for the channel.

At step 305, the user of mobile device 5 activates the application program installed on mobile device 5, as described above and provides log-in information. At step 310, the application program sends a login request to platform server 100. In one embodiment, platform server 100 stores all data relating to mobile device 5. In other embodiments, mobile device 5 has some data storage capability for data relating to the application program, and so in some of these embodiments, mobile device 5 includes as a part of the login request, an identification of the channel to be displayed. Typically, this channel is the one that the user has designated as her or his start-up channel, or if no designation has been made, then the last channel from the previous usage session, or a channel selected in accordance with the user's preferences, or a randomly selected channel.

At step 312, platform server 100 receives the log-in request. In the embodiment where all data is stored at platform server 100, then platform server 100 retrieves the start-up channel for this user. Otherwise, platform server 100 extracts the start-up channel from the log-in request. Platform server 100 then checks whether the channel is operative, typically by accessing a status table stored in data storage 110, or if the status table has not been recently updated for the start-up channel, then by querying the start-up channel directly.

If the start-up channel is inoperative, then at step 314, platform server 100 sends an appropriate message to mobile device 5, and at step 316 mobile device 5 displays the message, such as in status label area 515 shown in FIG. 4A and discussed below, or via another suitable display such as a pop-up window. From the viewpoint of the user of mobile device 5, such messages result in a smoother service than if the user had to rely on the channel for messages, since (i) channels do not necessarily provide consistent messages across channels, and (ii) communication set-up is harder from mobile device 5 than from platform server 100, as platform server 100 has a much higher bandwidth connection to communication network 75 than mobile device 5 has. The message may be a status message, such as “channel on-air only between home country 0800-1800 hours” or “channel at capacity, try later”, or an error message such as “channel not in service”.

If the start-up channel is operative, then at step 318, platform server 100 sends the network address for the channel to mobile device 5. Let it be assumed that content server 200 provides the start-up channel for the user of mobile device 5.

At step 320, mobile device 5 receives the network address for the start-up channel, and at step 322, mobile device 5 sends a request to content server 200 for the channel to be streamed to itself.

At step 324, content server 200 receives the request for streaming of the start-up channel, and at step 326, provides the requested channel to mobile device 5. In some cases, platform server 100 may also arrange for ads from ad server 150 to be merged with the stream from content server 200.

At step 328, mobile device 5 receives the streamed start-up channel, and displays the channel in video display area 520 of FIG. 4A, discussed below. If the channel is an audio-only format, then a suitable graphic or advertisement is displayed in video display area 520.

At this point, the user of mobile device 5 can control provision of service according to the menu structure discussed below with respect to FIGS. 4A-4E. If the user does nothing, the start-up channel will continue to display.

Let it be assumed that the user performs a channel search, such as by selecting, at the screen of FIG. 4A, menu button 535, which replaces area 540 with the six buttons shown. Next, the user actuates button 582 to request a search. As shown in FIG. 4D, the screen display on mobile device 5 now changes to a search screen. Let it be assumed that the user types “martial a” as his/her search term.

At step 350, the application program in mobile device 5 creates a search request incorporating the user's search term “martial a”, and sends the search request to platform server 100.

At step 352, platform server 100 receives the user's search request, and applies the search to its repository of channel information, the repository being stored in storage 110. Let it be assumed that three channels are located in response to the search request.

At step 354, platform server 100 checks the status of the channels located in response to the search request.

At step 356, platform server 100 sends a response message to mobile device 5 including the three channels found by the search, appropriate descriptive information for the channels, the network address for each of the channels, and an indication of whether each channel is or is not available. A channel is available when it is operating and has capacity to stream to another user. Otherwise, a channel is unavailable.

It is very advantageous for the user to know whether a channel is available prior to requesting the channel, as it saves the user's time and avoids the frustration of being denied a connection.

At step 358, mobile device 5 receives the response from platform server 100 and displays the results to the user such as depicted in the search results screen of FIG. 4D, discussed in detail below. At this point, the user can take any of the actions enabled by the screen. In some embodiments, server 100 updates the display on mobile device 5 at regular intervals, such as every 3 minutes. In other embodiments, the special application program executing in mobile device 5 requests updates at regular intervals, such as every 5 minutes, when the user has left the search results screen on the display for the length of the update interval.

Let it be assumed that the user selects one of the displayed channels for viewing, such as by actuating the play button next to the channel name in FIG. 4D. Let it further be assumed that the selected channel is provided by content server 220.

At step 360, the application program in mobile device 5 creates a channel request incorporating the channel selected by the user at step 358, and sends the channel request to content server 220.

At step 362, content provider 220 receives the request for channel connection, and at step 364, content provider 220 provides the requested channel stream to mobile device 5.

At step 368, mobile device 5 receives the streamed channel, and displays the channel in video display area 520 of FIG. 4A.

At this point, the user of mobile device 5 can control provision of service according to the menu structure discussed below with respect to FIGS. 4A-4E. If the user does nothing, the current channel will continue to display.

A similar sequence to that shown in FIG. 3B occurs if the user, instead of performing a search, requests the favorites list for the user. Specifically, mobile device 5 sends a request for its favorites list to server 100, which retrieves the user's favorites list and checks availability of the channels on the user's favorites list. Server 100 then sends to mobile device 5 the favorites list, including the network address and availability status for each of the channels in the favorites list. The favorites list is displayed on mobile device 5, and the user selects a channel. Mobile device 5 sends a request to the appropriate content server, and the channel is streamed to mobile device 5 and displayed to the user.

It is very advantageous for the user to know whether a channel is available prior to requesting the channel, as it saves the user's time and avoids the frustration of being denied a connection.

Generally, a user navigates through screen displays using a touch screen, cursor controlled by arrow keys, or other method such as a joystick, touch pad, and so on. In some embodiments, other navigation devices and/or procedures are available, such as voice commands; the navigation options presented below may be actuated in a variety of ways depending on the embodiment.

Generally, a user enters text by tapping on a field, such as a search box, and the device's operating system opens the field for stylus handwriting. Alternatively, the user enters text using the device keyboard or keypad.

FIG. 4A shows a screen display for mobile device 5. The screen display includes mobile operating system task bar 500 located at the top and enabling the user to change from the program described herein to other programs on mobile device 5, selection icon area 505 located under task bar 500 at the left, channel label area 510 under task bar 500 at the center-to-right area and immediately atop status label area 515, video display area 520 in the center, and bottom task bar 540 at the bottom. Bottom task bar 540 includes controls button 525 at its left side, favorites button 530 at its center, and menu 535 button at its right side.

Mobile operating system task bar 500 may be the task bar provided by the Microsoft Windows mobile operating system. Alternatively, a different mobile operating system may be used, and the position of task bar 500 may change accordingly.

Selection icon area 505 shows the group of channels that the user is currently browsing, and is operative to display one of four icons: all 550—browse all available channels, favorites 552—browse only the channels previously selected as favorites, filter 554—browse only the channels selected through filtering (see FIG. 4C), and search 556—browse only the channels resulting from the last search (see FIG. 4D). The icon can be changed by the user, such as by clicking on it, and also automatically changes to reflect the user's actions as appropriate. When the icon changes, status label 515 correspondingly changes, such as to display the currently active filtered channels list.

Channel label area 510 displays the channel which is currently being viewed. The name of the channel can be taken from platform server 100 or from the stream currently displayed.

Status label area 515 is used to advise the status of the progress of connecting to a new channel. When a connection is in progress, one of the following messages is displayed: Connecting, Buffering, Waiting For. Status label area 515 is also used to display error messages such as “low bandwidth”; when displaying an error message, the background color changes to an exception-indicating color, such as red.

Video display area 520 displays the currently tuned channel, as streamed from its source. As described below, the user can alternatively switch to a full screen display mode for the currently tuned channel.

Bottom task bar 540 has buttons that, when actuated via a touch screen or cursor, expand to different sub-menus of buttons, as described below. Generally, each button on a sub-menu has an icon and a small descriptive label at the bottom (not shown in FIG. 4). The expanded series generally has a line or highlight mechanism to indicate which button the cursor is on. Typically, if a user does not actuate any button on a sub-menu for a predetermined time period, such as 10 seconds, the display returns to showing bottom task bar 540. Alternatively, the user can close a sub-menu by an explicit action, as discussed below.

Controls button 525 leads to a menu of six buttons 560, 562, 564, 566, 568, 570.

Button 560 is labeled ‘Vol+’; pressing/selecting this button increases the device volume by 5%; when the device volume is at 100%, pressing this button has no effect.

Button 562 is labeled ‘Vol−’; pressing/selecting this button decreases the device volume by 5%; when the device volume is at 0%, pressing this button has no effect.

When pressing any of the volume change buttons, the Information label appears for a certain time displaying the current volume level with a number (0-100).

Button 564 is labeled ‘Info’; pressing/selecting this button makes the Info screen appear (see FIG. 4B).

Button 566 is labeled ‘Previous’; pressing/selecting this button makes the application tune the previous channel within the selection made.

Button 568 is labeled ‘Next’; pressing/selecting this button makes the application tune the next channel in the selection made.

When selecting the Previous/Next buttons rapidly, channel label area 510 displays the list of channels that the user is moving through, such as “Filter” or “All”, while status label area 515 displays the name of the channel presently selected. Tuning the new channel occurs when the user stops pressing the Previous or Next buttons. This functionality allows fast browsing of available channels in a list.

Button 570 is labeled ‘Stop’, or in some embodiments, ‘Pause’; this button stops the stream, turning stream display area 520 area into black. The name of the channel is maintained in channel label area 510. The word “stopped” (or “paused”) appears status label area 515.

Favorites button 530 leads to a display of up to a predetermined number of fields, such as four fields, shown as channel 572, 574, 576, 578, and a menu of four buttons. The fields contain the names of channels previously selected as favorites, and serve as shortcut buttons to the channels. If a channel is unavailable, then the channel's field is specially highlighted, such as being displayed in a different color, or blinking, or in a different font, or with a strikethrough line or icon.

Button 569 is labeled ‘My Favs’; pressing/selecting this button leads to a screen (not shown) for managing favorites, such as reordering, deleting and so on.

Button 567 is labeled “Add/Remove” and enables “one-click” addition or deletion of the channel being viewed relative to the user's favorites list. Button 567 operates in the same manner as button 586 of FIG. 4A, button 652 of FIG. 4B, button 722 of FIG. 4C, and button 822 of FIG. 4D.

Button 571 is labeled ‘Previous’; pressing/selecting this button makes the next as-yet-undisplayed favorite channel appear in one of fields 572, 574, 576, 578.

Button 573 is labeled ‘Next’; pressing/selecting this button makes the previously displayed favorite channel appear in one of fields 572, 574, 576, 578.

Through suitable navigation procedures, not discussed here for brevity, the user can control whether fields 572, 574, 576, 578 are affected by buttons 571, 573 as a group, or individually, that is, whether the displayed favorites advance by chunks or one-by-one.

Button 575 is labeled ‘OK’; pressing/selecting this button closes the favorites sub-menu.

Menu 535 button leads to a menu of six buttons 580, 582, 584, 586, 588, 590.

Button 580 is labeled ‘TV list’; actuating this button makes the TV List Screen appear (see FIG. 4C).

Button 582 is labeled ‘Search’; actuating this button makes the Search Screen appear (see FIG. 4D).

Button 584 is labeled ‘Info’; actuating this button makes the Info Screen appear (see FIG. 4B).

Button 586 is labeled ‘Add/remove’, and is displayed in a first color such as green with a plus sign (+) to add a channel to the user's favorites if the channel is not already included, or is displayed in a second color such as red with a minus sign (−) to remove a channel from the user's favorites if the channel is included.

Button 588 is labeled ‘Full Scrn’; actuating this button makes video display area 520 expand to all or most of the display area of mobile device 5. Additionally, the stream may rotate from portrait to landscape mode, to better fit the full screen into the display area. Touching in any area of the screen or pressing the keyboard will make the application exit from full screen and go back to the main screen.

Button 590 is labeled “Ch”; actuating this button makes the Service Provider Screen appear (see FIG. 4E).

FIG. 4B shows the Channel Information screen invoked through button 564 or button 584 (see FIG. 4A) or button 724 (see FIG. 4C) or button 824 (see FIG. 4D). The purpose of this screen is to provide information relating to a single channel, either the channel that the user is watching or the channel that the user has selected on a text screen. The Channel Information screen includes, from the top, channel label 605 providing the name of the channel, category 610 providing the category of the channel, country 615 providing the country of origin of the channel, language 620 providing the language of the channel, channel description 625 providing a short description of the channel created by the service provider providing service through platform 100, a user comments section and a channel information bar. The short description generally includes the channel's URL for direct access through communication network 75.

The user comments section has a horizontal navigation area with previous and next buttons, and sometimes hyperlinked words, to view additional user-provide comments. The user comments section also has author area 630 indicating the author of the currently displayed comment, creation date area 635 indicating the date of creation of the currently display comment, and comment text area 640 for displaying a user created comment.

The channel information bar includes six buttons:
play button 650 to display the current channel;
add/remove button 652 to add or remove the current channel from the user's favorites group;
comment button 654 leading to a channel comment screen where the user can add a comment for the current channel;
previous button 656 to go to a previous channel;
next button 658 to go to a next channel; and
back button 660 to close the Channel Information screen and return to the previous screen.

The channel comment screen is invoked by actuating comment button 654, and enables a user to enter a comment relating to the channel for viewing by other users of the channel in comment area 680. Platform server 100 automatically supplies the user's screen name (log-in name) in name area 670. The user then actuates send button 685 to have their comment stored, or back button 690 to depart the screen without saving their comment. If the comment is stored, after moderation, it is placed so that it will be the new most recent comment for the channel

FIG. 4C shows the TV List screen invoked through button 580. The TV List screen has a top label area, a middle channel listing area and a bottom button bar.

The TV List screen top label area includes Filter On/Off label 705 for displaying “FILTER ON” or “FILTER OFF” if filtering has occurred, and the category of the filter with the number of channels identified by the filtering.

The TV List screen middle channel listing area includes a listing of channels for browsing. Each streaming channel occupies two lines, the top line being the name of the channel and the bottom line identifying the country of origin of the channel, its language, and in some cases, other information such as the channel's primary category and an indicator such as “V” or “R” to indicate live video (V) or recorded information (R). To the right of each channel is a play icon, so that the channel can be displayed by simply clicking on the icon. If the channel is part of the user's favorites group, a heart icon appears to the left of the channel listing, such as from channel 712. Other icons may appear, such as a star for a recommended channel, or a starburst for a popular channel.

As explained above, server 100 checks availability of the channels, and if a channel is unavailable, the display of the channel indicates its unavailability, such as by displaying it in a different color, or with a strikethrough line or icon. Channel 714 is shown with a strikethrough icon on its play button, to indicate that this channel is unavailable for play.

At the bottom of the TV List screen middle channel listing area are fields labeled “This 718” and “Total 719”, separated by a slash (/). Total 719 shows the total number of pages of viewable information, while This 718 shows the current page number being viewed.

When a channel provides stored television programming, rather than streamed programming, its listing is somewhat different. Generally, the top line is the name of the stored program, while the bottom line is the content provider and a brief description of the program.

The TV List screen bottom button bar includes six buttons:
filter button 720 for invoking a filter pop-up window enabling a user to select filtering by one of category, country or language. The filter pop-up window includes a Cancel button, a List All button for simply listing all channels and an Ok button for applying the selected filtering to the list of all channels. When the Ok button is actuated, filter button 720 changes its appearance to indicate that filtering is active and selection area 505 displays filtering icon 554;
add/remove button 722 to add or remove the current channel from the user's favorites group;
information button 724 to invoke the Channel Information screen (see FIG. 4B);
previous button 726 to go to a previous page;
next button 728 to go to a next page; and
back button 730 to close the TV List screen and return to the previous screen.

FIG. 4D shows the Search screen invoked through button 582. The Search screen enables a user to enter any word, part of a word or letter, and returns the list of channels with every coincidence in the name, country, language, tags, or description. The user can enter text by any suitable technique.

The Search screen provides an area for entering the text that is to be searched, such as “martial a”, a Cancel button, a List All button, and a Search button. The Cancel button is for terminating the search and returning to the main screen, shown in FIG. 4A. The List All button turns off any filters and returns to making all repository channels available to the user. The Search button, when actuated, returns a search results screen.

The search results screen shows, at the top, the search string (“martial a”), followed, in parentheses by the number of channels satisfying the search (“(3)”). The search results screen shows, in the middle, a listing of channels in the format used in the TV List screen (see FIG. 4C) and a This 846/Total 847 similar to This 718/Total 719. The search results screen shows, at the bottom, a button bar having six buttons:
search button 820 for performing another search;
add/remove button 822 to add or remove the current channel from the user's favorites group;
information button 824 to invoke the Channel Information screen (see FIG. 4B);
previous button 826 to go to a previous page of the search results (when the search results occupy more than will fit into one display screen);
next button 828 to go to a next page of the search results (when the search results occupy more than will fit into one display screen); and
back button 830 to close the search screen and return to the previous screen.

FIG. 4E shows the Service Provider screen invoked through button 590. The majority of the screen comprises statistics such as most popular channels and program schedules, and news items that scroll as new items arrive. When the user first registers with platform server 100, the user can specify types of news that the user is interested in, on an include or exclude basis. At the bottom, there is a button bar having six buttons:
news button 920 for returning to the display of news items;
help button 922 for invoking a help screen (not shown) having frequently asked questions (FAQs), usage tips, contact information for customer service, and so on;
share button 924 for inviting a friend to register for the free tv repository service;
log-in button 926 returns the user to the log-in screen, so that the user may sign in under a different account, or turn off the automatic log in feature for this device;
log-out button 928 serves as a log out button; and
back button 930 to close the Service Provider screen and return to the main screen shown in FIG. 4A.

The user can share an invitation to the free tv repository service in any of at least three different ways. First, the user can send the mobile device application program to another user via Bluetooth protocol using the device's operating system transfer program. Second, the user can send a link to the home page of platform server 100 by sending a short message service (SMS) message to a specified name and phone number. Third, the user can send an e-mail to another user having at least one of (i) a link to the home page of platform server 100, (ii) a link to a downloadable mobile device application program, and (iii) executable software for mobile device application program.

Although an illustrative embodiment of the present invention, and various modifications thereof, have been described in detail herein with reference to the accompanying drawings, it is to be understood that the invention is not limited to this precise embodiment and the described modifications, and that various changes and further modifications may be effected therein by one skilled in the art without departing from the scope or spirit of the invention as defined in the appended claims.

What is claimed is:

1. A repository for television channels available through a communication network, comprising:
a server for coupling to the communication network to provide information from the repository in response to a request, and
a data storage for storing the repository, the repository having a record for each of the television channels, the record including an operational status of the television channel, the television channel operative in a streaming mode, the television channel provided by a party other than a provider of the repository.

2. The repository of claim 1, wherein the server is also for querying each of the channels in the repository to obtain the operational status of the channel.

3. The repository of claim 1, wherein the request is a search request, and the information provided from the repository in response to the search request includes operational status information for each of the channels satisfying the search request.

4. The repository of claim 1, wherein the data storage is also for storing a favorite channels list for a user of the repository.

5. The repository of claim 1, wherein the request is a favorite channels request, and the information provided from the repository in response to the favorite channels request includes operational status information for each of the channels in the favorite channels list.

6. A method of using a repository for television channels available through a communication network, comprising:
coupling to the communication network to provide information from the repository in response to a request, and
storing the repository, the repository having a record for each of the television channels, the record including an operational status of the television channel, the television channel operative in a streaming mode, the television channel provided by a party other than a provider of the repository.

7. The method of claim 6, further comprising querying each of the channels in the repository to obtain the operational status of the channel.

8. The method of claim 6, wherein the request is a search request, and the information provided from the repository in response to the search request includes operational status information for each of the channels satisfying the search request.

9. The method of claim 6, further comprising storing a favorite channels list for a user of the repository.

10. The method of claim 9, wherein the request is a favorite channels request, and the information provided from the repository in response to the favorite channels request includes operational status information for each of the channels in the favorite channels list.
